(19) United States
(12) Patent Application Publication
(10) Pub. No.: US 2021/0400951 A1
(43) Pub. Date: Dec. 30, 2021

(54) BIRD-REPELLING APPARATUS, BIRD-REPELLING SYSTEM, AND BIRD-REPELLING METHOD USING BIRD-REPELLING APPARATUS

(71) Applicant: YAPENG WANG, Santa Clara, CA (US)

(72) Inventor: YAPENG WANG, Santa Clara, CA (US)

(21) Appl. No.: 16/917,865

(22) Filed: Jun. 30, 2020

(51) Int. Cl. A01M 29/16; A01M 29/10

(52) U.S. Cl. CPC A01M 29/16; A01M 29/10

(57) ABSTRACT

The present application discloses a bird-repelling method, a bird-repelling apparatus, and a bird-repelling system. The bird-repelling method includes steps of: controlling a light-emitting device to emit blue light; controlling a sound producing device to emit sound waves; and repelling birds by the bird-repelling apparatus integrating blue light irradiation and sound wave emission. The blue light bird-repelling mode and the sound wave bird repelling mode complement each other. Light waves and sound waves generate a resonance effect, which can repel birds more effectively without causing harm to humans or birds. The present application can be widely applied to various fields requiring bird repelling, such as aviation, high-speed railways, electric power, agriculture, and the like.

### TECHNICAL FIELD

The present application relates to the field of light irradiation bird repelling, and more particularly, to a bird-repelling method, a bird-repelling apparatus, and a bird-repelling system.

### BACKGROUND

The bird collision problem (a flight problem caused by bird-aircraft collision) is a recognized worldwide problem, and causes huge losses to the global aviation industry every year. At present, people adopt physical methods, chemical methods, biological methods and other methods to repel birds by stimulating the sense of hearing, vision, and smell of birds or other means. These methods and means, used alone or in combination, can repel birds to a certain extent, and effectively reduce the probability of the bird-aircraft collision risk. In addition, the bird damage also includes collision of birds with high-speed trains running at a high speed, crop yield reduction due to crop eating by birds, and impact of bird activities on the safety of power transmission lines. Therefore, exploring effective bird-repelling technologies has become an important direction of scientific and technological development.

Studies show that about 40% of bird collision problems occur at night. However, due to limited conditions at night, some bird-repelling methods in airports, such as bird repelling by falcons and visual bird-repelling measures by color wind wheels, terrorist eyes, and the like, cannot achieve a satisfactory bird-repelling effect. At present, a laser-based bird-repelling technology has been developed. However, because the energy of the laser exceeds upper limits that humans and birds can bear and may cause irreversible damage to the vision of humans and birds, the laser-based bird-repelling technology has certain limitations in use. Studies show that at present, green light is mostly adopted for bird repelling.

### SUMMARY

An objective of the present application is to provide a bird-repelling method, a bird-repelling apparatus, and a bird-repelling system to solve the problem that existing laser-based bird repelling causes great harm to humans and birds, and eliminate the prejudice of people on bird repelling by light waves. The present application integrates light wave bird repelling using blue light and sound wave bird repelling. The sound wave bird repelling can assist the light wave bird repelling to compensate for a blind area existing in the light irradiation range, and light waves and sound waves can generate resonance, to scare birds more effectively, so that an excellent bird-repelling effect is achieved.

In order to solve the above problems, the present application provides a bird-repelling method, including steps of: controlling a light-emitting device to emit blue light; and controlling a sound producing device to emit sound waves.

The present application further provides a bird-repelling apparatus, including a light-emitting device configured to emit blue light, a sound producing device configured to emit sound waves, a power supply configured to supply power, and a control chip. The control chip is coupled to the light-emitting device and the sound producing device, and controls the light-emitting device and the sound producing device to be switched on or off. An on-off time control circuit is arranged on the control chip, and includes a first on-off time circuit and a second on-off time circuit. The first on-off time circuit controls the sound producing device to be switched on. The second on-off time circuit controls the light-emitting device to be switched on.

The present application further provides a bird-repelling system, including the plurality of bird-repelling apparatuses. The plurality of bird-repelling apparatuses are respectively arranged at intervals at two sides and two ends of an airport runway. A distance between the bird-repelling apparatuses at the same side ranges from 800 m-1000 m.

The present application has the following beneficial effects: the present application repels birds by using blue light to irradiate airport airspaces, high-speed railway lines, electric power facilities, farmland, etc. Experimental studies show that the blue light can effectively stimulate the vision of birds, so that birds make a stress response and actively leave the area irradiated by light rays, thus achieving the objective of harmlessly repelling birds. In addition, sound waves are introduced to repel birds at the same time. By integrating the light wave bird repelling and the sound wave bird repelling, sound waves can further compensate for the blind area in the light wave range, and light waves and sound waves can generate resonance, to scare birds more effectively, so that an excellent bird-repelling effect is achieved.

### BRIEF DESCRIPTION OF DRAWINGS

The included accompanying drawings are used to provide further understanding of the embodiments of the present application, constitute a part of the specification, and are used to illustrate implementations of the present application and explain the principle of the present application together with literal descriptions. Apparently, the accompanying drawings in the following descriptions are merely some embodiments of the present application, and a person of ordinary skill in the art can also obtain other accompanying drawings according to these accompanying drawings without involving any creative effort. In the figures:

FIG. 1 is a basic principle block diagram of a bird-repelling apparatus of the present application.

FIG. 2 is a schematic structure diagram (1) of the bird-repelling apparatus of the present application.

FIG. 3 is a schematic structure diagram (2) of a bird-repelling apparatus of the present application.

FIG. 4 is a schematic diagram of a bird-repelling method of the present application.

FIG. 5 is a schematic diagram of a bird-repelling system of the present application.

FIG. 6 is a comparison diagram of bird-repelling effects of different light rays according to the present application.

FIG. 7 is a comparison diagram of bird-repelling effects of blue light in different wave bands according to the present application.

FIG. 8 is a comparison diagram of bird-repelling effects of combining different blue light with sound waves according to the present application.

In the figures, 1 denotes a power supply; 2 denotes a light-emitting device; 3 denotes a sound producing device; 4 denotes a cabinet; 5 denotes a first rotating bracket; 6 denotes a driving mechanism; 7 denotes a second rotating bracket; 8 denotes an upper cabinet; 9 denotes a support post; 10 denotes a lower cabinet; 11 denotes a hollow structure; 12 denotes a first connecting shaft; 13 denotes a second connecting shaft; 14 denotes a case; 15 denotes a loudspeaker; 16 denotes a casing; 17 denotes a light-emitting body; 18 denotes an on-off time control circuit; 19 denotes a first on-off circuit; 20 denotes a second on-off circuit; 21 denotes a wavelength adjustment circuit; 22 denotes a continuous irradiation circuit; 23 denotes a strobe control circuit; 24 denotes a control chip; 25 denotes a first rotating shaft; 26 denotes a second rotating shaft; 100 denotes a bird-repelling apparatus; and 200 denotes a bird-repelling system.

### DETAILED DESCRIPTION OF EMBODIMENTS

Specific structures and functional details disclosed herein are merely representative, and are intended to describe the objectives of the exemplary embodiments of the present application. However, the present application may be specifically implemented in many alternative forms, and should not be construed as being limited to the embodiments set forth herein.

In the description of the present application, it should be understood that orientation or position relationships indicated by the terms such as “center”, “transverse”, “on”, “below”, “left”, “right”, “vertical”, “horizontal”, “top”, “bottom”, “inside”, and “outside” are based on orientation or position relationships shown in the accompanying drawings, and are used only for ease and brevity of illustration and description, rather than indicating or implying that the mentioned apparatus or component must have a particular orientation or must be constructed and operated in a particular orientation. Therefore, such terms should not be construed as limiting of the present application. In addition, terms “first” and “second” are only used to describe the objective and cannot be understood as indicating or implying relative importance or implying a quantity of the indicated technical features. In view of this, a feature defined to be “first” or “second” may explicitly or implicitly include one or more features. In the description of the present application, unless otherwise stated, “a plurality of” means two or more than two. In addition, the terms “include”, “comprise” and any variant thereof are intended to cover non-exclusive inclusion.

In the description of the present application, it should be noted that unless otherwise explicitly specified or defined, the terms such as “mount”, “install”, “connect”, and “connection” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components. Persons of ordinary skill in the art may understand the specific meanings of the foregoing terms in the present application according to specific situations.

The terminology used herein is for the purpose of describing specific embodiments only and is not intended to be limiting of exemplary embodiments. As used herein, the singular forms “a”, “an” and “the” are intended to include the plural forms as well, unless the context clearly indicates otherwise. It should be further understood that the terms “include” and/or “comprise” when used in this specification, specify the presence of stated features, integers, steps, operations, elements, and/or components, but do not preclude the presence or addition of one or more other features, integers, steps, operations, elements, components, and/or combinations thereof.

The present application is further described below with reference to the accompanying drawings and preferred embodiments.

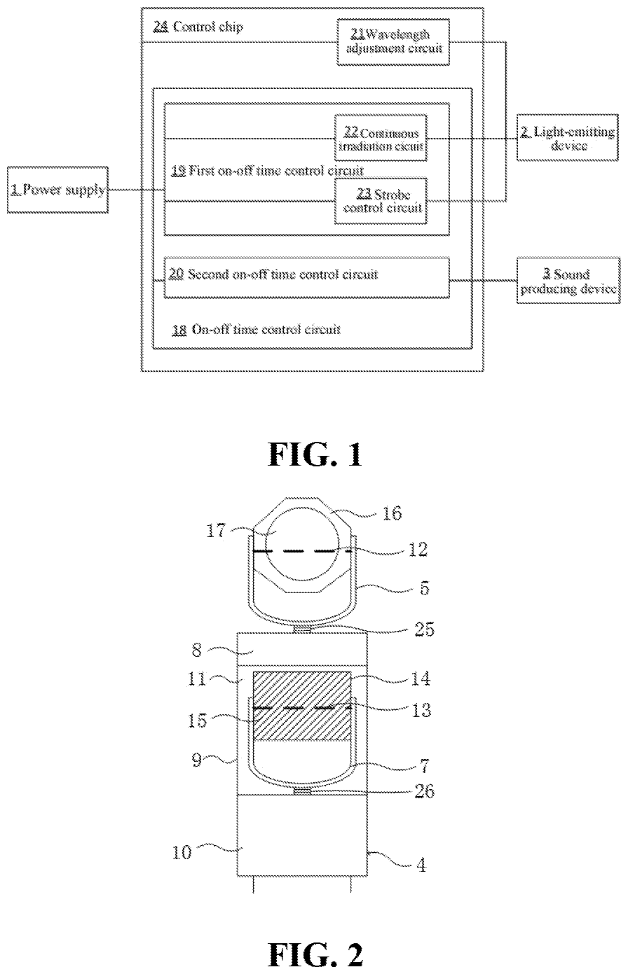

As shown in FIG. 1, the present application discloses a bird-repelling apparatus. The bird-repelling apparatus includes a light-emitting device 2 configured to emit blue light, a sound producing device 3 configured to emit sound waves, and a power supply 1. The power supply 1 is respectively coupled to the light-emitting device 2 and the sound producing device 3, and respectively controls whether the light-emitting device emits the blue light or not and whether the sound producing device emits the wound waves or not. A wavelength of the blue light emitted by the light-emitting device ranges from 465 nm-470 nm. When the wavelength of the blue light is 470 nm, and an irradiation intensity is 100000 lx, the stimulation on the vision of birds is more obvious. The range of the blue light emitted by the light-emitting device is limited, and a blind area exists. Therefore, the sound producing device is additionally provided to emit the sound waves to assist the light waves in repelling birds to achieve an excellent bird-repelling effect, and further expand the bird-repelling range.

In the present application, mainly by switching on and off the light-emitting device and the sound producing device at the same time, light waves and sound waves can generate resonance, thus achieving an excellent bird-repelling effect. When the sound producing device emits the sound waves, the light-emitting device adopts continuous blue light for irradiation, and may also adopt strobe blue light for irradiation. Specifically, an environment visibility value is detected, and the detected environment visibility value is compared with a preset threshold, and different blue light is selected for irradiation according to a comparison result. When the environment visibility value is less than or equal to the preset threshold, the light-emitting device adopts the continuous blue light for irradiation. When the environment visibility value is greater than the preset threshold, the light-emitting device adopts the strobe blue light for irradiation, and a strobe period of the strobe blue light is 2 s-5 s. During experiments, by using 4 s as a boundary line, experiments are respectively performed at the periods of less than 4 s and more than 4 s.

Correspondingly, the power supply is respectively coupled to the sound producing device 3 and the light-emitting device 2 through a control chip 24. An on-off time control circuit 18 is arranged on the control chip 24. The on-off time control circuit 18 includes a first on-off time circuit 19 and a second on-off time circuit 20. The first on-off time circuit controls the sound producing device to be switched on and off. The second on-off time circuit controls the light-emitting device to be switched on and off. By means of this configuration, the light-emitting device and the sound producing device may be switched on at different time points or at the same time. When the light-emitting device emits the blue light, the sound producing device may select to emit the sound waves or select to not emit the sound waves. For example, the light-emitting device is switched on under a dark condition, and the sound producing device is switched on 24 h a day. The dark condition is the condition at night or some conditions with low visibility in gloomy weather. Or the sound producing device is switched on beyond the normal sleep time of human beings, and the light-emitting device is switched on 24 h a day. The normal sleep time of human beings ranges from 22:00-8:00 and 12:30-14:00. Or the switching-on time of the sound producing device ranges from 8:00-12:30 and 14:00-22:00, and the switching-on time of the light-emitting device ranges from 18:00-6:00. Of course, other time may also be freely set. The time setting may be performed according to season differences or weather differences. The switching-on time of the light-emitting device and the switching-on time of the sound producing device may be the same, different or partially the same, may be determined according to weather conditions, and may also be set according to other factors of an airport.

A wavelength adjustment circuit 21 is further arranged on the control chip. The wavelength of the blue light is adjusted by the wavelength adjustment circuit. Corresponding adjustment is performed for different kinds of birds. A wavelength adjustment range of the wavelength adjustment circuit 21 is from 465 nm-470 nm. The second on-off circuit 20 includes a strobe control circuit 23 and a continuous irradiation circuit 22. The strobe control circuit and the continuous irradiation circuit are respectively coupled to the light-emitting device. During blue light irradiation, different modes, i.e., a continuous irradiation mode and a strobe mode, may be selected. The modes are respectively controlled by the strobe control circuit and the continuous irradiation circuit, and may be freely switched. If any circuit in the control chip fails, the circuit can be removed and replaced without affecting the normal operation of other circuits.

The entire bird-repelling apparatus may be divided into a principle control portion and a structure portion. The principle control portion mainly adopts a relevant circuit on the control chip as a main structure, and adopts a work mode of controlling the sound producing device and the light-emitting device by the relevant circuit. The structure portion mainly includes a rotating portion and a fixed portion. For the principle control, reference may be made to a specific mechanism.

As shown in FIG. 2, the bird-repelling apparatus further includes a cabinet 4, a first rotating bracket 5, a first rotating shaft 25, and a driving mechanism 6. The cabinet 4 is configured to accommodate the power supply 1 and the control chip 24. The cabinet 4 includes an upper cabinet 8, a plurality of support posts 9, and a lower cabinet 10. The plurality of support posts are arranged corresponding to a plurality of corners of the upper cabinet and the lower cabinet. The plurality of support posts are respectively connected to the upper cabinet and the lower cabinet. The plurality of support posts jointly define a hollow structure 11. The hollow structure 11 is formed between the upper cabinet 8 and the lower cabinet 10. The first rotating bracket 5 is vertically arranged on an upper surface of the upper cabinet. The light-emitting device 2 is arranged on the first rotating bracket 5. The first rotating shaft 25 connects the first rotating bracket 5 and the upper cabinet 8, and is configured to rotate the first rotating bracket. The driving mechanism drives the first rotating bracket to rotate. The first rotating bracket drives the light-emitting device to rotate. A rotating speed of the first rotating bracket ranges from 10 r/min-20 r/min. The driving mechanism includes a motor. Electric energy of the motor may be provided through batteries, and the motor may also be connected to the power supply. The power supply may be a solar panel and in other power supply forms. When the power supply provides electric energy, the motor drives the first rotating bracket to rotate, so that the light-emitting device can also rotate. In this way, 360° irradiation is achieved.

The bird-repelling apparatus includes a second rotating bracket 7 and a second rotating shaft 26. The second rotating bracket is arranged in the hollow structure on an upper surface of the lower cabinet. The second rotating shaft 26 connects the second rotating bracket 7 and the lower cabinet 10, and is configured to rotate the second rotating bracket. The sound producing device is arranged in the hollow structure. The sound producing device is arranged on the second rotating bracket. The sound producing device is equivalent to be arranged under the light-emitting device, and can also rotate. Therefore, the sound wave sound producing device brings interference to low-altitude birds. A bird-repelling blind area of the light-emitting device is compensated for. In addition, after the sound producing device causes the interference on the low-altitude birds, the interfered birds fly to a blue light irradiation area, and the stimulation of the blue light on the vision of birds is more obvious. Of course, the first rotating bracket 5 and the second rotating bracket 7 may synchronously rotate, and may rotate at different rotating speeds so that an irradiation range of the blue light emitted by the light producing device is not overlapped or is only partially overlapped with a spreading range of the sound waves emitted by the sound producing device, thus enlarging a bird-repelling area.

The bird-repelling apparatus includes a first connecting shaft 12. The first rotating bracket is of a U-shaped structure. The light-emitting device is fixedly connected to the first connecting shaft 12, and is suspended at a middle position of the first rotating bracket 5 through the first connecting shaft 12. The bird-repelling apparatus includes a second connecting shaft 13. The second rotating bracket 7 is also of a U-shaped structure. The sound producing device is fixedly connected to the second connecting shaft, and is suspended at a middle position of the second rotating bracket through the second connecting shaft. The U-shaped structure is more convenient to place the sound producing device and the light-emitting device. Rotating connection may also be set among the connecting shafts and two vertical ends of the U-shaped structure. Small-angle pitching can be realized. The light rays of the blue light emitted by the light-emitting device can be upwards inclined relative to a horizontal plane at an inclination angle of 45° to 60°, so that the bird-repelling area control is changed, and a bird-repelling space area is expanded.

Further, the sound producing device 3 includes a case 14 and a loudspeaker 15. The loudspeaker 15 is placed in the case 14. A length of the case 14 is less than a spacing between two vertical ends of the second rotating bracket 7. The light-emitting device includes a casing and a light-emitting body. The light-emitting body is arranged in the casing. The casing is in a shape of a regular polygon. An outer diameter of the casing is less than or equal to a spacing between two vertical ends of the first rotating bracket, so that the casing can be clamped in the U-shaped structure.

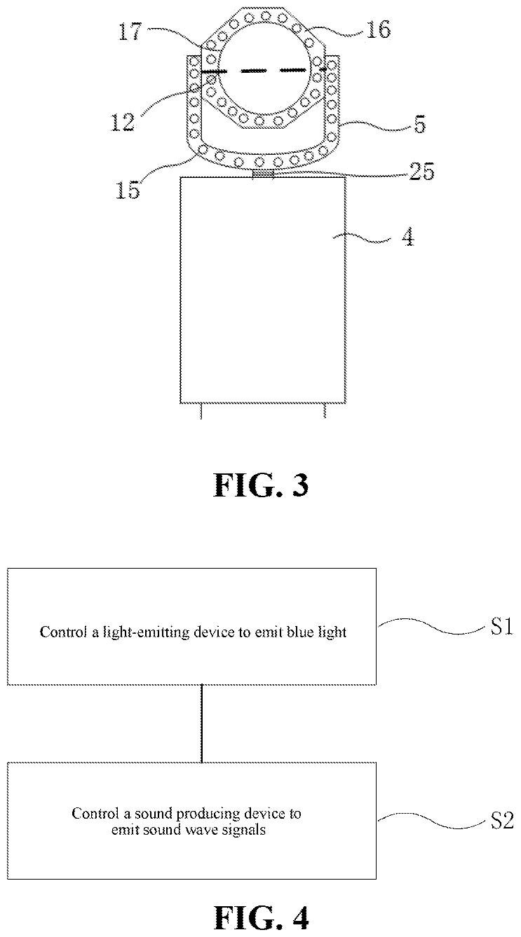

As shown in FIG. 3, as another embodiment of the present application, the present application further discloses a bird-repelling apparatus. The bird-repelling apparatus includes a cabinet 4, a first rotating bracket 5, a first rotating shaft 25, a first connecting shaft 12, and a driving mechanism 6. The cabinet 4 is configured to accommodate a power supply 1 and a control chip 24. The first rotating bracket is of a U-shaped structure, and is vertically arranged on an upper surface of the cabinet. A light-emitting device is arranged on the first rotating bracket. The first rotating shaft connects the first rotating bracket and the cabinet, and is configured to rotate the first rotating bracket. The driving mechanism drives the first rotating bracket to rotate so that the first rotating bracket drives the light-emitting device to rotate. The light-emitting device is fixedly connected to the first connecting shaft, and is suspended at a middle position of the first rotating bracket through the first connecting shaft. The light-emitting device includes a casing and a light-emitting body. The casing is in a shape of a regular polygon. A gap is formed between the light-emitting body and the casing. The sound producing device includes a plurality of loudspeakers configured to emit sound waves. The loudspeakers surround the light-emitting body and are arranged in round holes in the gap and in round holes formed in two vertical ends of the first rotating bracket. The sound producing device is divided into the plurality of loudspeakers to be embedded into the round holes of the first rotating bracket and the casing of the light-emitting device. The sound producing device can rotate along with the light-emitting device. The sound waves and the light waves are combined to repel birds in the same area to achieve an excellent bird-repelling effect.

As shown in FIG. 4, the present application further discloses a bird-repelling method using the above bird-repelling apparatus. The bird-repelling method includes steps of:
S1: controlling a light-emitting device to emit blue light; and
S2: controlling a sound producing device to emit sound waves.

For the blue light, a wavelength of the blue light may be set to be 470 nm through a wavelength adjustment circuit. The bird-repelling device integrating light waves and the sound waves has a greater application range, and light waves and sound waves can compensate for each other.

The blue light may be strobe blue light, and may also be continuous blue light. During practical bird repelling, switching between the continuous blue light and the strobe blue light may be performed.

The present application is mainly characterized in that light waves and sound waves are adopted at the same time to repel birds. The light-emitting device and the sound producing device are switched on and switched off at the same time. The environment visibility is detected, a detected environment visibility value is compared with a preset threshold, and different blue light is selected for irradiation according to a comparison result. When an environment visibility value is less than or equal to the preset threshold, the light-emitting device adopts the continuous blue light for irradiation. When the environment visibility value is greater than the preset threshold, the light-emitting device adopts the strobe blue light for irradiation.

In addition, in a mode of selecting different blue light for irradiation, whether the sound producing device and the light-emitting device rotate or not may also be selected, and an included angle between light rays of the blue light emitted by the light-emitting device and a horizontal line may also be adjusted. Birds are repelled in combination of the sound waves and the light waves. An excellent bird-repelling effect can be achieved by itself. The sound producing device and the light-emitting device rotate, so that the bird-repelling range can be expanded. In addition, a movable device is superior to a fixed device as for the stimulation effect on birds.

Of course, the light-emitting device respectively adopts continuous irradiation and strobe irradiation at different times. When the light-emitting device adopts the continuous irradiation, the sound producing device is set to emit the sound waves at any time point in continuous irradiation time. When the light-emitting device adopts the strobe irradiation, the sound producing device continuously emits the sound waves in strobe irradiation time. If the sound waves are suddenly emitted at any time point, birds can be easily scared. Therefore, an excellent bird-repelling effect can be achieved by combining sound waves with the blue light irradiation.

Further, the light-emitting device and the sound producing device are switched on or off within a set time period. The set time period is divided into four identical periods of time including a first period of time, a second period of time, a third period of time, and a fourth period of time. In the first period of time, the sound producing device is switched on to emit the sound waves, and the light-emitting device is switched on to adopt the continuous blue light for irradiation. In the second period of time, the sound producing device is kept switched on to emit the sound waves, and the light-emitting device is switched off, and is then switched on again to adopt the strobe blue light for irradiation. In the third period of time, the sound producing device is kept switched on to emit the sound waves, the light-emitting device is kept switched on to adopt the strobe blue light for irradiation, and the sound producing device and the light-emitting device rotate at the same time. In the fourth period of time, the sound producing device is kept switched on to emit the sound waves, the sound producing device and the light-emitting device keep rotating at the same time, and the light-emitting device is switched off, and is then switched on again to adopt the continuous blue light for irradiation. The four periods of time may be alternated, and may be set to have the same or different durations. Of course, a bird-repelling scheme of one period of time may be used as a bird-repelling option of the entire bird-repelling apparatus.

In addition, the light-emitting device and the sound producing device may be alternately switched on to be used within a set time period. The set time period is divided into four identical periods of time including a first period of time, a second period of time, a third period of time, and a fourth period of time. In the first period of time, the sound producing device is switched on to emit the sound waves. In the second period of time, the light-emitting device is switched on to adopt the continuous irradiation. In the third period of time, the sound producing device is switched on to emit the sound waves. In the fourth period of time, the light-emitting device is switched on to adopt the strobe irradiation. A period of the strobe irradiation ranges from 2 s-5 s. In the set time period, the switching-on and switching-off of sound wave emission and blue light irradiation can be freely set. The sound wave emission and the blue light irradiation can be alternately switched on in different periods of time, or can be switched on at the same time in the same time period.

The durations of the first period of time to the fourth period of time may be selected to be the same or different. For example, if the set time period is 1 h, the four periods of time may be set to be 15 min at the same time. Of course, the blue light switching-on time and the sound wave switching-on time may be set to be different. Therefore, the light-emitting device and the sound producing device are alternately used, the electric power consumption can be reduced, and excellent energy-saving and environment-friendly effects are achieved.

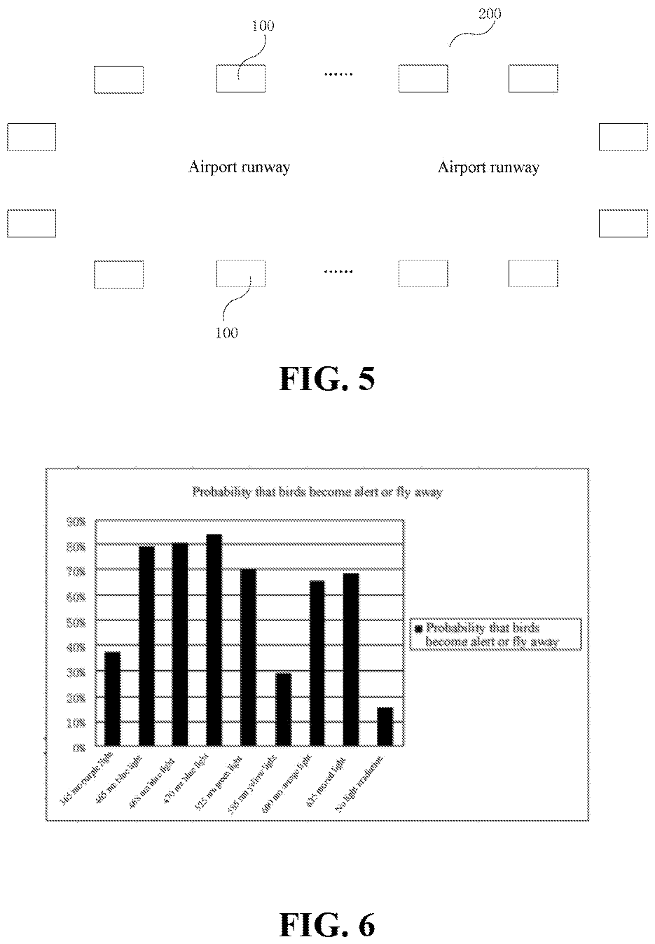

As shown in FIG. 5, the present application further discloses a bird-repelling system, including the plurality of bird-repelling apparatuses as mentioned above. The plurality of bird-repelling apparatuses are respectively arranged at intervals at two sides and two ends of an airport runway. A distance between the bird-repelling apparatuses at the same side ranges from 800 m-1000 m. Inclination angles formed between the light rays of the blue light emitted by the light-emitting device in each piece of the bird-repelling apparatus and a horizontal plane are different. The distance between the apparatus may also be adjusted according to practical environments. The distribution distance of the bird-repelling apparatus in an area in which birds often occur may be set to be shorter.

Illustration is performed hereafter by a first group of comparative experiments: an LED searchlight was put into a birdcage to observe responses of birds in the birdcage to blue light in different wave bands.

Three kinds of common large and medium-sized North American birds, specifically including 10 Canada geese, 10 laughing gulls, and 10 common cranes, were purchased from a flower and bird market, and were respectively placed in cages of 0.5 m in length, width, and height to be fed. During the experiments, each kind of birds were irradiated sequentially by LED purple light with a wavelength of 365 nm, blue light with a wavelength of 465 nm, blue light with a wavelength of 468 nm, blue light with a wavelength of 470 nm, green light with a wavelength of 525 nm, yellow light with a wavelength of 585 nm, orange light with a wavelength of 600 nm, and red light with a wavelength of 635 nm in a position with a 25 m distance from the cages, and whether birds generated alerting or escaping behaviors within 30 s or not was observed and recorded (video recording was performed at the same time to facilitate data analysis) to judge bird-repelling effects of LED light rays with different wavelengths on birds. The experiments were repeatedly performed for 3 times. Blank control experiments under the condition of switching off the blue light were in addition performed to judge the bird-repelling effect of the LED blue light after the experiments were completed. The experiment results are shown in FIG. 6.

The results show that the bird vision is more sensitive on the blue light with the wavelength of 470 nm, and the blue light has the excellent bird-repelling effect. The experiment data simultaneously prove that the LED blue light ranging from 465 nm-470 nm is superior to conventional green light bird repelling as for the bird-repelling effect. The conventional inherent thinking of regarding that the green light has an excellent bird-repelling effect is broken.

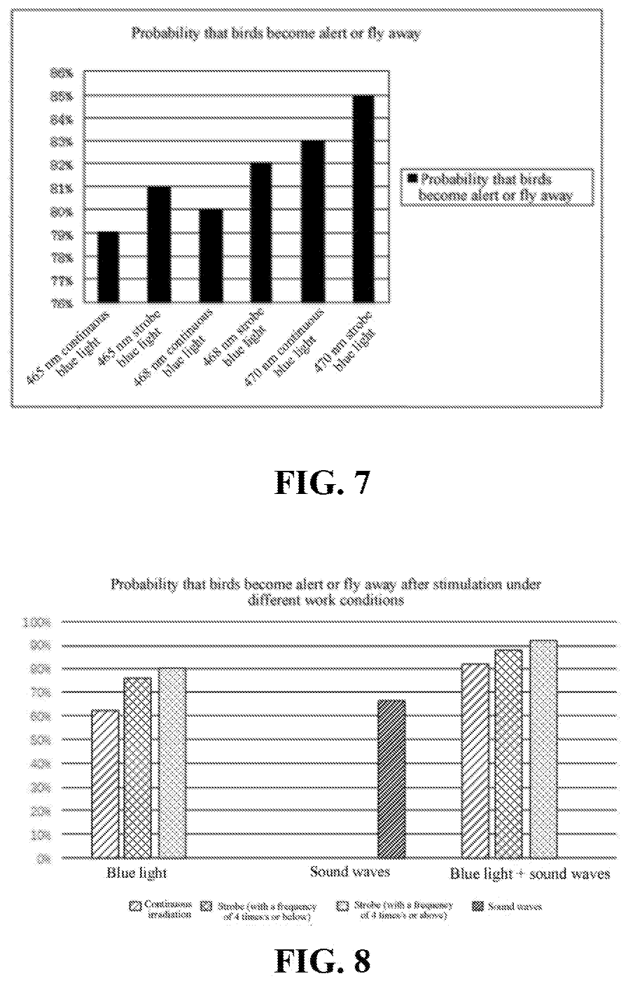

Blue light irradiation experiments were in addition performed on the above birds. During the experiments, LED continuous blue light and strobe blue light with the wavelengths of 465 nm, 468 nm, and 470 nm were respectively adopted to irradiate each kind of birds, and whether birds generated the alerting or escaping behaviors within 30 s or not was observed and recorded (video recording was performed at the same time to facilitate data analysis). The experiments were repeatedly performed for 3 times. An average value was calculated. The experiment results are shown in FIG. 7 below.

The results show that the probability that birds become alert or fly away during strobe blue light irradiation was higher than the probability that birds become alert or fly away during continuous blue light irradiation. It proves that the stimulation of the strobe moving blue light on birds is more obvious.

A second group of experiments were in addition performed on the above birds. The bird-repelling apparatus was put into the birdcages. During the experiments, birds were irradiated and stimulated by using blue light, sound waves, and a combination of the sound waves and the blue light, and whether birds generated the alerting or escaping behaviors within 30 s or not was observed and recorded (video recording was performed at the same time to facilitate data analysis). The experiments were repeatedly performed for 3 times. An average value was calculated. The experiment results are shown in FIG. 8 below.

The results show that the probability that birds become alert or fly away during the stimulation of the sound waves+the blue light was higher than the probability that birds become alert or fly away during blue light irradiation or sound wave stimulation. It proves that the stimulation of the combination of the sound waves and the blue light on birds is more obvious.

A third group of experiments were in addition performed on the above birds. The bird-repelling apparatus was put into the birdcages. During the experiments, birds were irradiated respectively by continuous blue light+sound waves, strobe blue light with a frequency of 4 times/s or below+sound waves, and strobe blue light with a frequency of 4 times/s or above+sound waves. The experiment results are shown in FIG. 8 below.

The results show that the probability that birds become alert or fly away during the combination of the strobe blue light with the frequency of 4 times/s or above and the sound waves was higher than the probability that birds become alert or fly away during the combination of the continuous blue light and the sound waves and the combination of the sound waves and the irradiation of the strobe blue light with the frequency of 4 times/s or below. It proves that the stimulation of the combination of the strobe blue light with the frequency of 4 times/s or above and the sound waves on birds is more obvious.

It should be noted that on the premise of not affecting the implementation of specific solutions, the descriptions of the steps in this solution shall not be construed as limiting the execution order of the steps. A step mentioned earlier that another step may be executed before, after, or concurrently with the another step. Such execution orders shall all fall within the scope of the present application as long as this solution can be implemented.

The foregoing contents are detailed descriptions of the present application in conjunction with specific preferred embodiments, and it should not be considered that the specific implementation of the present application is limited to these descriptions. Persons of ordinary skill in the art can further make simple deductions or replacements without departing from the concept of the present application, and such deductions or replacements should all be considered as falling within the protection scope of the present application.

What is claimed is:

1. A bird-repelling method, comprising steps of:
controlling a light-emitting device to emit blue light; and
controlling a sound producing device to emit sound waves.

2. The bird-repelling method according to claim 1, wherein the light-emitting device and the sound producing device are switched on or off at the same time, and the light-emitting device adopts continuous blue light for irradiation.

3. The bird-repelling method according to claim 1, wherein the light-emitting device and the sound producing device are switched on or off at the same time, and the light-emitting device adopts strobe blue light for irradiation.

4. The bird-repelling method according to claim 1, wherein the light-emitting device and the sound producing device are switched on or off at the same time, and the bird-repelling method further comprises steps of:
detecting an environment visibility value, comparing the detected environment visibility value with a preset threshold, and selecting different blue light irradiations according to a comparison result,
wherein when the environment visibility value is less than or equal to the preset threshold, the light-emitting device adopts continuous blue light for irradiation; and when the environment visibility value is greater than the preset threshold, the light-emitting device adopts strobe blue light for irradiation.

5. The bird-repelling method according to claim 3, wherein a strobe period of the strobe blue light ranges from 2 s-5 s.

6. The bird-repelling method according to claim 1, wherein the light-emitting device and the sound producing device are switched on or off at the same time, and the bird-repelling method further comprises steps of:
controlling the sound producing device to rotate about itself; and
controlling the light-emitting device to rotate about itself,
wherein the sound producing device and the light-emitting device have the same rotating direction and the same rotating speed.

7. The bird-repelling method according to claim 1, wherein the light-emitting device and the sound producing device are switched on or off at the same time, and the bird-repelling method further comprises a step of:
adjusting an included angle between light rays of the blue light emitted by the light-emitting device and a horizontal line,
wherein an adjustment range of the included angle is from 45°-60°.

8. The bird-repelling method according to claim 1, wherein the light-emitting device and the sound producing device are switched on or off at the same time, and the bird-repelling method further comprises steps of:
detecting an environment visibility value, comparing the detected environment visibility value with a preset threshold, and selecting different blue light irradiations according to a comparison result;
controlling the sound producing device to rotate about itself; and
controlling the light-emitting device to rotate about itself,
wherein a rotating direction of the sound producing device is the same as a rotating direction of the light-emitting device, and a rotating speed of the light-emitting device is different from a rotating speed of the sound producing device; when the environment visibility value is less than or equal to the preset threshold, the light-emitting device adopts continuous blue light for irradiation; and when the environment visibility value is greater than the preset threshold, the light-emitting device adopts strobe blue light for irradiation.

9. The bird-repelling method according to claim 1, wherein the light-emitting device and the sound producing device are switched on or off within a set time period;
the set time period is divided into four identical periods of time comprising a first period of time, a second period of time, a third period of time, and a fourth period of time;
in the first period of time, the sound producing device is switched on to emit the sound waves, and the light-emitting device is switched on to adopt continuous blue light for irradiation;
in the second period of time, the sound producing device is kept switched on to emit the sound waves, and the light-emitting device is switched off, and is then switched on again to adopt strobe blue light for irradiation;
in the third period of time, the sound producing device is kept switched on to emit the sound waves, the light-emitting device is kept switched on to adopt the strobe blue light for irradiation, and the sound producing device and the light-emitting device rotate at the same time; and
in the fourth period of time, the sound producing device is kept switched on to emit the sound waves, the sound producing device and the light-emitting device keep rotating at the same time, and the light-emitting device is switched off, and is then switched on again to adopt the continuous blue light for irradiation.

10. The bird-repelling method according to claim 9, wherein a rotating speed of the light-emitting device is less than a rotating speed of the sound producing device,
wherein the rotating speed of the light-emitting device is less than or equal to the rotating speed of the sound producing device.

11. The bird-repelling method according to claim 1, wherein when the light-emitting device emits the blue light for irradiation, the sound producing device emits the sound waves at different time points,
wherein the light-emitting device adopts continuous blue light for irradiation, and the sound producing device emit sound waves at same time intervals, each time with a same duration.

12. The bird-repelling method according to claim 1, wherein the bird-repelling method further comprises steps of:
detecting an environment visibility value, comparing the detected environment visibility value with a preset threshold, and selecting different blue light irradiations according to a comparison result; and
monitoring the blue light adopted by the light-emitting device, and selecting on or off of the sound producing device according to different blue light irradiations,
wherein when the environment visibility value is less than or equal to the preset threshold, the light-emitting device adopts continuous blue light for irradiation, and the sound producing device is switched on; and when the environment visibility value is greater than the preset threshold, the light-emitting device adopts strobe blue light for irradiation, and the sound producing device is switched off.

13. The bird-repelling method according to claim 1, wherein the light-emitting device respectively adopts continuous irradiation and strobe irradiation in different time periods;
when the light-emitting device adopts the continuous irradiation, the sound producing device emit the sound waves at different time points which are set during continuous irradiation; and
when the light-emitting device adopts the strobe irradiation, the sound producing device continuously emits the sound waves during strobe irradiation.

14. A bird-repelling apparatus capable of implementing the bird-repelling method according to claim 1, the bird-repelling apparatus comprising:
a light-emitting device, configured to emit blue light;
a sound producing device, configured to emit sound waves;
a power supply, configured to supply power; and
a control chip, coupled to the light-emitting device and the sound producing device, and controlling the light-emitting device and the sound producing device to be switched on or off,
wherein an on-off time control circuit is arranged on the control chip, and comprises a first on-off time circuit and a second on-off time circuit; the first on-off time circuit controls the sound producing device to be switched on; and the second on-off time circuit controls the light-emitting device to be switched on.

15. The bird-repelling apparatus according to claim 14, wherein the second on-off circuit comprises a strobe control circuit and a continuous irradiation circuit, and the strobe control circuit and the continuous irradiation circuit are respectively coupled to the light-emitting device.

16. The bird-repelling apparatus according to claim 14, further comprising:
a cabinet, configured to accommodate the power supply and the control chip, wherein the cabinet comprises an upper cabinet, a plurality of support posts and a lower cabinet, the plurality of support posts are arranged corresponding to a plurality of corners of the upper cabinet and the lower cabinet, the plurality of support posts are respectively connected to the upper cabinet and the lower cabinet, the plurality of support posts jointly define a hollow structure, and the hollow structure is formed between the upper cabinet and the lower cabinet;
a first rotating bracket, vertically arranged on an upper surface of the upper cabinet, wherein the light-emitting device is arranged on the first rotating bracket;
a first rotating shaft, connecting the first rotating bracket and the upper cabinet and configured to rotate the first rotating bracket;
a driving mechanism, driving the first rotating bracket to rotate so that the first rotating bracket drives the light-emitting device to rotate;
a second rotating bracket, arranged in the hollow structure on an upper surface of the lower cabinet; and
a second rotating shaft, connecting the second rotating bracket and the lower cabinet and configured to rotate the second rotating bracket,
wherein the sound producing device is arranged on the second rotating bracket in the hollow structure, and the second rotating bracket rotates under the action of the driving mechanism so as to drive the sound producing device to rotate.

17. The bird-repelling apparatus according to claim 16, comprising:
a first connecting shaft, fixedly connected to the light-emitting device, wherein the light-emitting device is suspended at a middle position of the first rotating bracket through the first connecting shaft; and
a second connecting shaft, fixedly connected to the sound producing device, wherein the sound producing device is suspended at a middle position of the second rotating bracket through the second connecting shaft;
wherein the first rotating bracket is of a U-shaped structure, and the second rotating bracket is of a U-shaped structure.

18. The bird-repelling apparatus according to claim 17, wherein the light-emitting device comprises:
a casing in a shape of a regular polygon, wherein an outer diameter of the casing is less than or equal to a spacing between two vertical ends of the first rotating bracket; and
a light-emitting body, arranged in the casing; and
wherein the sound producing device further comprises:
a case in a rectangular shape, wherein a length of the case is less than or equal to a spacing between two vertical ends of the second rotating bracket; and
a loudspeaker, arranged on the case.

19. The bird-repelling apparatus according to claim 15, further comprising:
a cabinet, configured to accommodate the power supply and the control chip;
a first rotating bracket, vertically arranged on an upper surface of the cabinet, wherein the light-emitting device is arranged on the first rotating bracket;
a first rotating shaft, connecting the first rotating bracket and the cabinet and configured to rotate the first rotating bracket;
a driving mechanism, driving the first rotating bracket to rotate so that the first rotating bracket drives the light-emitting device to rotate; and
a first connecting shaft, fixedly connected to the light-emitting device, wherein the light-emitting device is suspended at a middle position of the first rotating bracket through the first connecting shaft,
wherein the first rotating bracket is of a U-shaped structure, the light-emitting device comprises a casing and a light-emitting body, the casing is in a shape of a regular polygon, a gap is formed between the light-emitting body and the casing, and a plurality of round holes are formed in the gap; and
the sound producing device comprises a plurality of loudspeakers configured to emit sound waves, the loudspeakers surround the light-emitting body and are arranged in the round holes in the gap and in round holes formed in two vertical ends of the first rotating bracket.

20. A bird-repelling system, comprising a plurality of bird-repelling apparatuses according to claim 14, wherein the plurality of bird-repelling apparatuses are respectively arranged at intervals at two sides and two ends of an airport runway, wherein a distance between the bird-repelling apparatuses at the same side ranges from 800 m-1000 m.
